(19) United States
(12) Patent Application Publication
(10) Pub. No.: US 2002/0175806 A1
(43) Pub. Date: Nov. 28, 2002

(54) Electronic tag binary selection method

(76) Inventors: Willem J. Marneweck, Gilbert, AZ (US); Stephanus P.J. Duvenhage, Phoenix, AZ (US)

Correspondence Address: BAKER BOTTS, LLP, 910 LOUISIANA, HOUSTON, TX, 77002-4995, US

(21) Appl. No.: 09/866,229

(22) Filed: May 25, 2001

(51) Int. Cl. H04Q 5/22

(52) U.S. Cl. 340/10.33; 340/10.2; 340/10.42

(57) ABSTRACT

A system and method for identifying tags with a reader, wherein the tags have unique tag identification codes, having a transmitter of a wake-up signal from the reader to a tag within a field of the reader; a transmitter of a signal corresponding to an initial portion of the tag identification code from the tag to the reader; a transmitter of an initial acknowledgement signal responsive to the signal corresponding to the initial portion of the tag identification code; and a recorder in the reader of an initial portion of a tag confirmation code corresponding to the initial acknowledgement signal. The system send and acknowledges subsequent portions of the identification codes from the tags. If a tag does not receive an acknowledgement of its code, the tag becomes inactive. The system continues until only one tag remains active and transmits its entire code for acknowledgement. This tag is selected.

### BACKGROUND OF THE INVENTION

Identification and access control systems allow access when an electronic tag is brought into a low frequency magnetic field generated by a reader and identified. Systems of this type may be used in any number of applications, such as a store checkout station where universal product codes are read from each product. Tags or labels on each item of merchandise can be read, prices tabulated, payments made and inventory counts adjusted. Identification systems having tags which communicate with a reader make it possible for the customer to check-out without having to remove all items of merchandise from a shopping basket to read the items individually. All items may be identified by reading the basket contents while they are in the basket.

Similarly, electronic tags may be used to monitor the location of particular objects. A system could be used to determine whether persons have come or gone from a building. A system could be used to determine whether cars have passed a checkpoint.

In identification and access control systems, more than one tag may be in the reader field at the same time causing transmission collision. The reader must be able to identify or select each individual tag, notwithstanding the transmission collision. Typical identification and access control systems have tags which only communicate in one direction with the reader. This necessitates the use of complicated time slot assignment or address transmission schemes.

In particular, prior solutions fall into two basic categories: (1) systems that use randomized time slots; and (2) systems that transmit the whole address or serial number for every iteration. In time slot based systems, during the manufacturing process a random number is programmed into each tag. This random number is used to respond during a specific time slot. The time slot can also be dynamically reassigned when a collision occurs. In addressing based systems, the address base is divided up and only tags with an identification address higher or lower respond. The full address that is used for comparison is sent out every time. The address space is subdivided until a unique tag is selected. Several illustrative systems are described.

U.S. Pat. No. 5,539,394, incorporated herein by reference, discloses a method for identifying a plurality of tags simultaneously placed in close proximity to a read station. Hashing is used to reduce the amount of time needed to read the possible tags in the space. Reading is accomplished using radio communication with a combination of broadcast and time division multiplex architectures. In particular, the reader first broadcasts a set of parameters to all tags in the read volume to initiate a series of time slots which synchronize the reader and tags. The tags use their unique identity to calculate a time slot in which it will communicate with the reader. Since many unique identities are involved, a hashing base number is used to group identities into the different time slots. The tags then transmit their identities to the reader during their assigned time slots. The reader transmits individual acknowledgements to all tags who successfully communicate with the reader. If multiple tags choose the same time slot, a collision occurs and no tag's communication is successful. Another read cycle is initiated by the reader with another hashing base number which hopefully assigns the previously collided tags to different time slots. This process is repeated until no more collisions are read.

U.S. Pat. No. 4,471,345, incorporated herein by reference, discloses a system wherein communication between portal units and identification tags is accomplished by continually radiating an interrogation signal consisting of a code pattern from each portal unit followed by a listening interval. Tags within range of such interrogation signal test the incoming signals for frequency, bit duration, bit rate, a preamble code and a facility identifying code. If the tag receives a valid signal to which it has been pre-programmed, the tag synchronizes itself with the signal and initiates a plurality of tag responses within a given overall response interval. Each response is transmitted during randomly selected time slots. Each tag is provided with it's own pseudo-random binary sequence generator and reply counter with the pseudo-random generator sequence by a signal derived from the carrier signal radiated by the tag.

U.S. Pat. No. 5,266,925, incorporated herein by reference, discloses an electronic identification tag interrogation method wherein a portal transmits an interrogation signal which is received by an electronic identification tag within its field of range. The interrogation signal includes an address which requests a response from every tag having an address greater than or equal to the address of the signal. If more than one reply is received by the portal, the interrogation address range is bisected and an interrogation signal including a mean address is retransmitted. The interrogation address is successfully bisected until a single response is isolated. When a single response is isolated, communication is directed between the portal and the identification tag. The interrogation system is then reset to isolate and identify any remaining tags.

U.S. Pat. No. 5,883,582, incorporated herein by reference, discloses a method of reading multiple tags located in a field of an interrogating antenna. The tags respond with periodic transmissions having large, non-transmission intervals between transmissions. The non-transmission intervals are fixed for a given tag, but are random between tags due to manufacturing tolerances and electrical components from which the tags are constructed. Thus, no coordination of transmissions from the interrogating antenna is required.

U.S. Pat. No. 5,726,630, incorporated herein by reference, discloses an identification system having an interrogator and a prerogative transponder. The interrogator includes a transmitter which transmits at least two independent interrogation signals to the transponders. The interrogator also has a receiver for receiving response signals from the transponders. The interrogator identifies the transponders from data in the received response signals. Each transponder comprises a receiver, a code generator and a transmitter. Upon receipt of at least one of the transmitted interrogation signals, the transponder transmits a response signal containing data which identifies it. The interrogation signals are relatively narrow band width signals at different frequencies. The receiver of each transponder has a relatively broad reception band width so that the transponder is responsive to one or more of the interrogation signals.

U.S. Pat. No. 5,591,951, incorporated herein by reference, discloses a system and method for simultaneously collecting serial number information from numerous coded radio frequency identity tags. Each tag has a unique multi-digit serial number that is stored in non-volatile ram. A reader transmits an ASCII code “D” character on a carrier of about 900 megahertz in a power illumination field having a frequency of about 1.6 gigahertz. A one (1) megahertz tone is modulated on the 1.6 gigahertz carrier as a timing clock for a microprocessor in each of the identity tags. Over 1,000 such tags may be in the vicinity of the reader and each is powered-up and clocked by the 1.6 gigahertz power illumination field. Each identity tag looks for the “D” interrogator modulated on the 900 megahertz carrier and each uses a digit of its serial number to time a response. Clear responses received by the reader are repeated for verification. If there is no verification where a wrong number is received by any identity tag, it uses a second digit together with the first to time out a more extended period for a response. Ultimately, the entire serial number will be used in the worst-case collision environments. Since the serial numbers are defined as being unique, the final possibility will be successful because a clear time-slot channel will be available.

U.S. Pat. No. 5,351,052, incorporated herein by reference, discloses a method of communicating between an interrogator and at least two transponders. The transponders each have a low frequency antenna which transmit a continuous low frequency subcarrier to serve as a clock signal for each antenna's associated transponder. Initially, a wake-up signal is sent by each of the low frequency antennas to its associated transponder. Following the wake-up signal, a unique signal is sent by each of the low frequency antennas to its associated transponder. The transponder stores its unique code in its memory. The transponder then sends a UHF signal response in a predetermined time period depending on the unique codes stored in each of the transponders. The time period in which the transponder sends its UHF signal response is unique to that transponder so that interference between responding transponders is avoided.

These solutions are typically slow and can address only a limited number of tags in the reader field. In time slot systems, the time slots are randomly assigned so that the response time is unpredictable and priorities cannot be assigned. In systems where the entire addresses or identity codes are transmitted, the systems are two slow for many applications.

Therefore, there is a need for an access control and identification system which quickly identifies specific electronic tags when multiple tags are in the reader field.

### SUMMARY OF THE INVENTION

The present invention takes advantage of bi-directional communication to address individual tags very quickly. Further, the invention provides that certain tags can be given higher priority and addressed first instead of relying on random priority. The system comprises a reader and several tags which transmit databits using pulse position modulation (PPM). The reader first transmits a long wake-up pulse to indicate the start of a new session which wakes up all of the tags in the field. After wake-up, the tags transmit the first bit of their identification codes. The reader acknowledges either a ‘1’ or a ‘0’ as being received by sending either a ‘1’ or a ‘0’, respectively. Tags that do not get an acknowledgment of the bit they transmitted go to sleep or become inactive. Tags that were acknowledged continue by transmitting the next bit of their individual identification codes. The process is repeated until all the bits in the identification code have been transmitted and only one tag is still active. If the reader receives a ‘2’ signal at any time during the selection process, the reader knows that more than one tag is in the field. The ‘2’ signal indicates simultaneous transmission of both a ‘1’ signal and a ‘0’ signal by different tags, and therefore reveals that multiple tags are still active. Once a tag is selected, an identification confirmation signal is sent from the reader to the identified tag. To identify the remaining tags, the reader again transmits a wake-up signal and the process is repeated.

An object of the invention is to provide a system wherein certain tags can be given higher priority and addressed first instead of relying on random priority.

A further object of the invention is to provide a system wherein tags are identified and selected at relatively much faster rates.

A further object of the invention is to provide a system for identifying tags by a reader wherein the system will always take the same time to identify and select each tag so as to give predictability to the system.

According to one aspect of the invention, there is provided a method for identifying tags with a reader, wherein the tags have unique tag identification codes, the method having the following steps: transmitting a wake-up signal from the reader to a tag within a field of the reader; transmitting a signal corresponding to an initial portion of the tag identification code from the tag to the reader; transmitting from the reader to the tag an initial acknowledgement signal responsive to the signal corresponding to the initial portion of the tag identification code; and storing in the reader an initial portion of a tag confirmation code corresponding to the initial acknowledgement signal.

According to a further aspect of the invention, there is provided a method for identifying tags with a reader, having the following steps: a) transmitting a wake-up signal from the reader to a tag within a field of the reader; b) transmitting a signal corresponding to an initial portion of a tag identification code from a tag to the reader, wherein all tags have unique tag identification codes; c) transmitting from the reader to a tag an acknowledgement signal responsive to the signal corresponding to the initial portion of the tag identification code; d) storing in the reader a portion of a tag confirmation code corresponding to the acknowledgement signal; e) deactivating a tag in the field upon the tag's reception of an acknowledgement signal from the reader which does not acknowledge a just-transmitted signal corresponding to a portion of the tag identification code from the tag; f) repeating steps b), c), d) and e) with respect to subsequent portions of the tag identification code for a tag in the field having an initial portion of the tag identification code which has been acknowledged by the acknowledgement signal; and g) transmitting a tag selection signal to a tag in the field upon compilation of the tag confirmation code.

According to still another aspect of the invention, there is provided a system for identifying objects within a field, the system having: a reader having a transmitter, a receiver and a processor, wherein the transmission range of the transmitter and receiver define the field; a plurality of tags each having a transmitter, a receiver and a microprocessor, wherein the tags are attachable to the objects to be identified, wherein each tag has a unique tag identification code and all codes are the same length, wherein the tags operate in active and inactive modes; wherein the reader transmits a wake-up signal from the reader to all tags in the field, whereby all tags in the field are made to be in the active mode; wherein all active tags within the field transmit a signal corresponding to an initial portion of their tag identification codes to the reader; wherein the reader transmits to all tags in the field an acknowledgement signal responsive to the tag signals corresponding to initial portions of the tag identification codes; and wherein the reader stores an initial portion of a tag confirmation code corresponding to an acknowledgement signal.

### BRIEF DESCRIPTION OF THE DRAWINGS

The present invention is better understood by reading the following description of non-limitative embodiments, with reference to the attached drawings wherein like parts in each of the several figures are identified by the same reference character, and which are briefly described as follows.

FIG. 1A is a graphic depiction of several items with tags in close proximity to a reader. In this figure, the reader is transmitting a signal.

FIG. 1B is a graphic depiction of the tags and reader shown in FIG. 1B, wherein the tags are transmitting signals.

FIG. 2 is a graphic depiction of internal components of a tag of the present invention.

FIG. 3 is a graphic depiction of internal components of a reader of the present invention.

FIG. 4A is a graphic depiction of a wake-up signal, a ‘0’ signal, and a ‘1’ signal which are transmitted by the reader.

FIG. 4B is a graphic depiction of a ‘0’ signal, a ‘1’ signal, and a ‘2’ signal which are received by the reader from the tags.

FIG. 5 is a flowchart of an embodiment of the algorithm of the present invention for controlling the reader.

FIG. 6 is a flowchart of an alternative embodiment of the algorithm of the present invention for controlling the reader.

FIG. 7 is a flowchart of an embodiment of the algorithm of the present invention for controlling the tags.

FIG. 8 is a graphic depiction of reader and tag signals wherein tag having identification code 0111 is selected.

FIG. 9 is a graphic depiction of reader and tag signals wherein tag having identification code 1101 is selected.

It is to be noted, however, that the appended drawings illustrate only typical embodiments of this invention and are therefore not to be considered limiting of its scope, as the invention may admit to other equally effective embodiments.

### DETAILED DESCRIPTION OF THE INVENTION

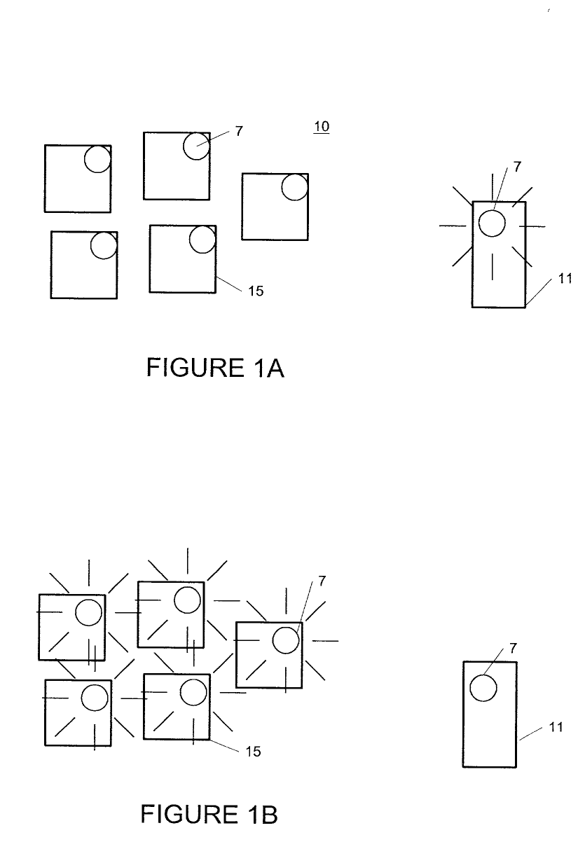

Referring to FIG. 1A, an identification and access control system 10 is shown wherein several objects 15 are brought in close proximity to a reader 11. The objects 15 may be animate or inanimate and are each equipped with a tag having an antenna 7. Reader 11 is equipped with an antenna 7 for communicating with the various tags. Through the antenna 7, the tags also have the ability to send and receive signals. The system 10 may be either an identification system or an access control system or both. The tags may be in the form of a tag, key, badge or transponder. The reader 11 generates a low frequency magnetic filed into which the objects 15 are brought for communication with the reader 11.

Each of the individual tags are assigned a unique identification code. For example, the code may be a binary code comprising any number of bits. Depending on the number of objects to be identified by the system 10, all of the tags are assigned unique identification codes all having the same number of bits. Of course, where a significant number of objects are to be identified by the system 10, a longer bit identification code length is required.

As shown FIG. 1B, the antenna 7 of the reader 11 is no longer transmitting a signal. Rather, the antennas 7 of the tags on the objects 15 are simultaneously transmitting signals. Generally, the system operates by the reader 11 transmitting a wake-up signal to each of the tags. Upon receipt of the wake-up signal, the tags respond by transmitting the first bit of their binary identification codes. Of course, the first bit of the identification code will either be a ‘1’ or a ‘0’. The reader responds with an acknowledgement by transmitting either a ‘1’ signal or a ‘0’ signal, as explained below. Tags that do not get an acknowledgment of the bit they transmitted go to sleep or are deactivated. Tags that do get an acknowledgment of the bit they transmitted, remain active and transmit the next bit of their identification codes. The process is repeated until one (1) tag remains active and all bits of the active tag's identification code are sent and acknowledged. This active tag is then selected and identified. The other tags may then be selected by transmitting the wake-up signal and repeating the process as described. This process is described in further detail below.

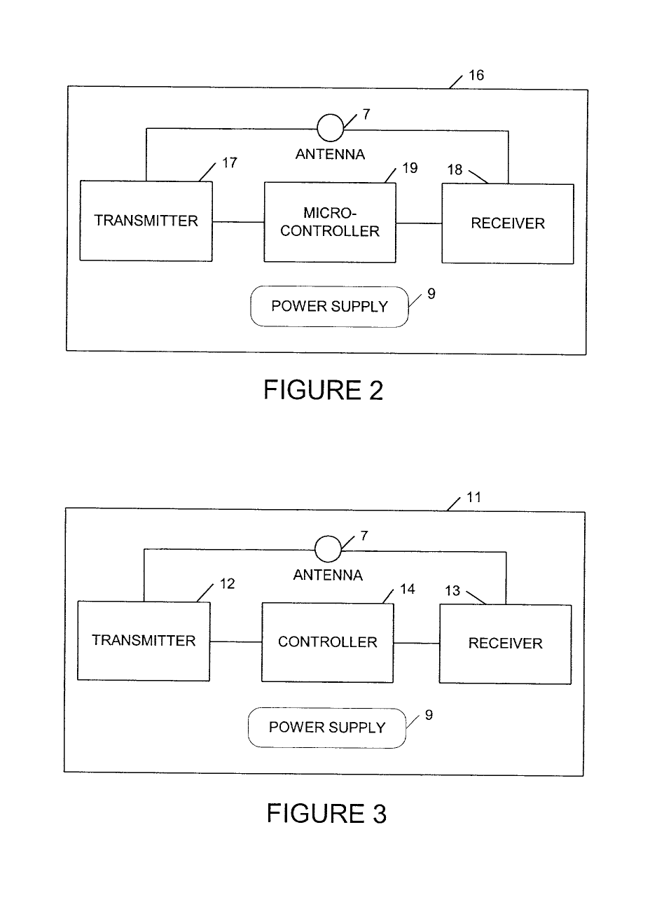

Referring to FIG. 2, a graphic diagram of internal components of the tags is shown. The tags 16 each have a microcontroller 19, a transmitter 17, a receiver 18 and an antenna 7. The transmitter 17 sends its signals through the antenna 7, while the receiver 18 receives signals through the antenna 7. The tags are powered by a power supply 9 which may be a battery, a supply energized by radiation from the reader, or any other means known to persons of skill in the art. The microcontroller 19 comprises memory capacity where the unique identification code and control information is stored.

Referring to FIG. 3, a graphic diagram of internal components of the reader 11 is shown. The reader 11 has a controller 14, a transmitter 12, a receiver 13, a power supply 9, and an antenna 7. The transmitter 12 sends its signals through the antenna 7, while the receiver 13 receives signals through the antenna 7. Depending on the embodiment of the invention, the controller 14 has programmable memory and a user interface to allow users to program certain aspects of the system. For example, whether the system prioritizes the tags when read by the reader could be a user defined feature.

According to one embodiment of the invention, the reader 11 generates a low frequency magnetic field into which the tags 16 are brought. Similarly, the tags 16 generate low frequency magnetic signals. Since the signals are transmitted at different times the tags do not become confused as to whether they are receiving a signal from the reader or another tag, as described more fully below. According to alternative embodiments, any transmission medium may be used to communicate signals between the reader 11 and the tags 16 including: LF, HF, VHF, UHF, etc. Other transmission media may also be used such as optic signal or acoustic signals. According to one embodiment, the reader 11 and tags 16 transmit databits using pulse position modulation (PPM). Ones and zeros are encoded. When two tags simultaneously transmit a ‘1’ signal and a ‘0’ signal, the reader will receive a combined or ‘2’ signal. A long wake-up pulse indicates the start of a new session, which wakes up all tags in the field of the reader.

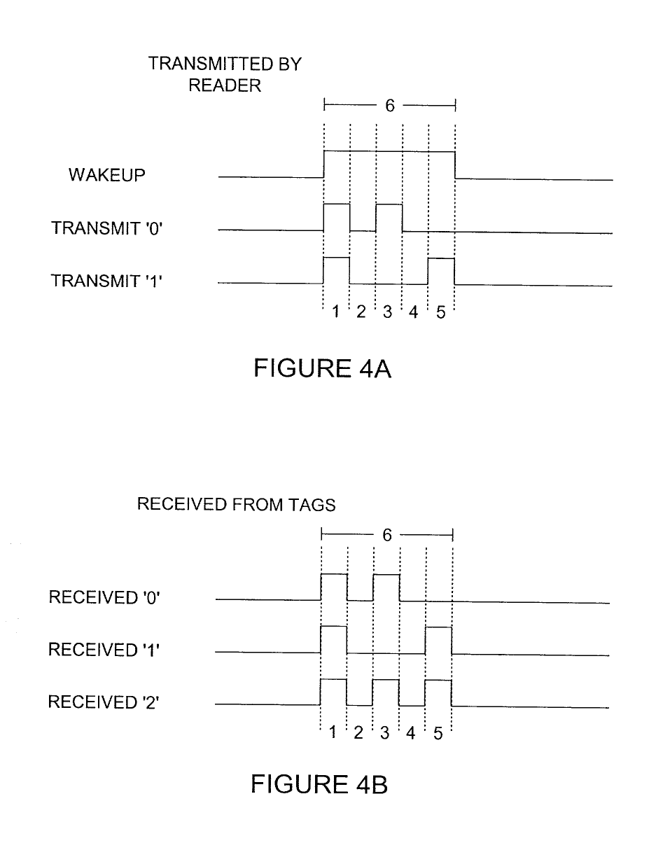

As shown in FIG. 4A, three different signals may be transmitted by the reader 11. The signals are transmitted over a time interval 6 comprising five units identified by characters 1, 2, 3, 4, and 5, respectively. A wake-up signal is generated by a positive pulse in all five time intervals 1-5. A transmission of a ‘0’ signal comprises positive pulses in the first unit 1 and the third unit 3 of the time interval 6. A transmission of a ‘1’ signal comprises positive pulses in the first time unit and the fifth time unit 5 of the time interval 6.

Referring to FIG. 4B, there are three possibilities for signals to be received by the reader 11 from a single or multiple tags 16. While each tag 16 may only transmit either a ‘0’ signal or a ‘1’ signal, multiple tags may transmit signals simultaneously. Thus, in addition to the ‘0’ signal and the ‘1’ signal, it is also possible for the reader 11 to receive a ‘2’ signal. The tags 16 transmit signals similar to those transmitted by the reader 11, wherein the transmission signal has a time interval 6 divided into time units 1, 2, 3, 4, and 5. The tags 16 transmit a ‘0’ signal comprising positive pulses in the first time unit 1 and the third time unit 3 of the time interval 6. A ‘1’ signal transmitted by the tags 16 is also similar to that of a ‘1’ signal sent by the reader 11 and comprises positive pulses in the first time unit 1 and the fifth time unit 5 of the time interval 6. If a ‘0’ signal and a ‘1’ signal are simultaneously transmitted by different tags, the reader will receive a ‘2’ signal. A ‘2’ signal has positive pulses in the first time unit 1, the third time unit 3, and the fifth time unit 5 of the time interval 6.

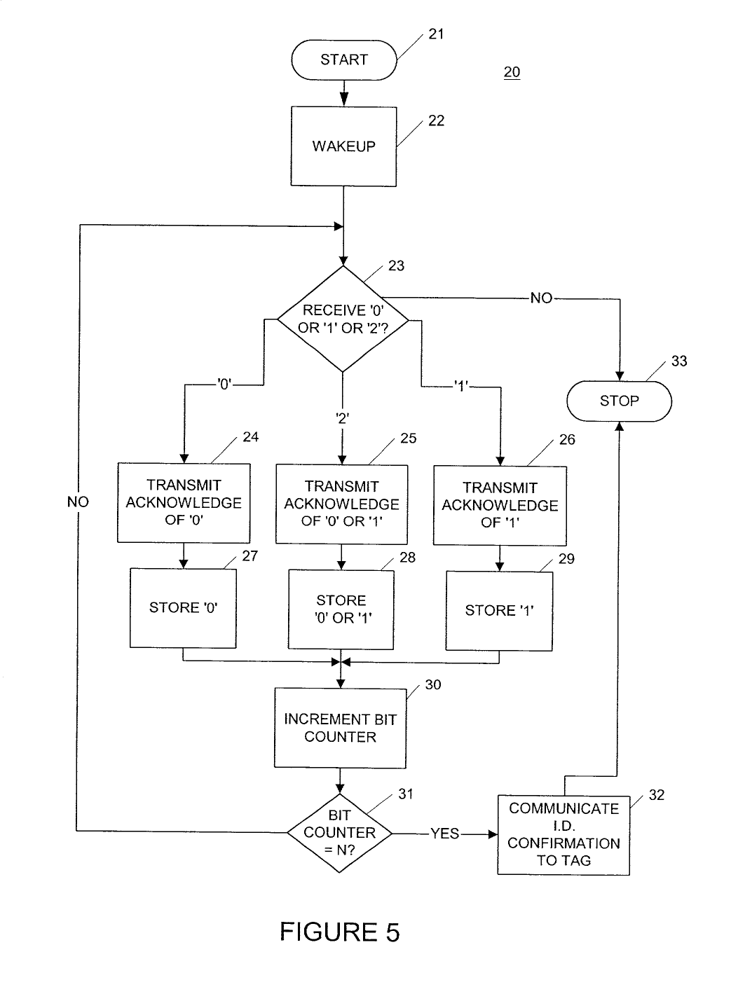

Referring to FIG. 5, an embodiment of the algorithm 20 of the present invention for control of the reader 11 is shown. The process begins at start block 21. The reader 11 sends a wake-up signal to all of the tags 16 within its field of transmission, as indicated by the wake-up block 22. Each of the tags 16 respond to the wake-up signal by transmitting the first bits of their unique identification codes. Of course, each tag 16 will send either a ‘0’ signal or a ‘1’ signal. The reader 11 determines whether it has received a ‘0’ signal, a ‘1’ signal, or a ‘2’ signal, as indicated at box 23. If no signals are received by the reader 11, the reader algorithm stops at box 33. If the reader 11 receives a ‘0’ signal at decision block 23, the reader 11 transmits a ‘0’ acknowledgement signal to the tags 16 as indicated at block 24. Next, the reader 11 stores a ‘0’ as the appropriate bit for the tag confirmation code, as shown at block 27. If the reader 11 receives a ‘1’ signal at decision block 23, the reader 11 transmits a ‘1’ acknowledgment signal to the tags 16. This step is indicated at block 26 of FIG. 5. Next, the reader 11 stores a ‘1’ as the appropriate bit value for the tag confirmation code as indicated at block 29. At decision block 23, if the reader 11 receives a ‘2’ signal, the reader 11 will transmit an acknowledgment signal of either ‘0’ or ‘1’. The decision whether to transmit a ‘0’ signal or a ‘1’ signal may be arbitrary or prioritized as discussed below. The transmission of this acknowledgment is indicated at box 25 in the flowchart. After transmission of this acknowledgment, the reader 11 stores a ‘0’ or a ‘1’, depending on which signal has been transmitted for the acknowledgment. This step in the process is indicated at box 28 in the flowchart. After the reader 11 has stored a value for the appropriate bit of the tag's confirmation code, it increments the bit counter as indicated at box 30. The reader 11 then determines whether the bit counter is equal to the total number of bits in the tag identification codes (N), as indicated at decision block 31. If the bit counter is not equal to the total number of bits (N), control within the algorithm is returned to decision block 23 to determine whether a signal has been received from a tags 16. In decision block 31, if the bit counter is equal to the total number of bits in the identification codes (N), then the reader 11 will communicate an identification confirmation signal to the tag identified, as indicated at block 32. Further communication can also take place like sending commands, reading, writing and encryption. Upon communication of this confirmation, the algorithm stops as indicated at block 33. The reader 11 is then free to start the process again at decision block 21 to identify further tags 16 responding to the reader 11.

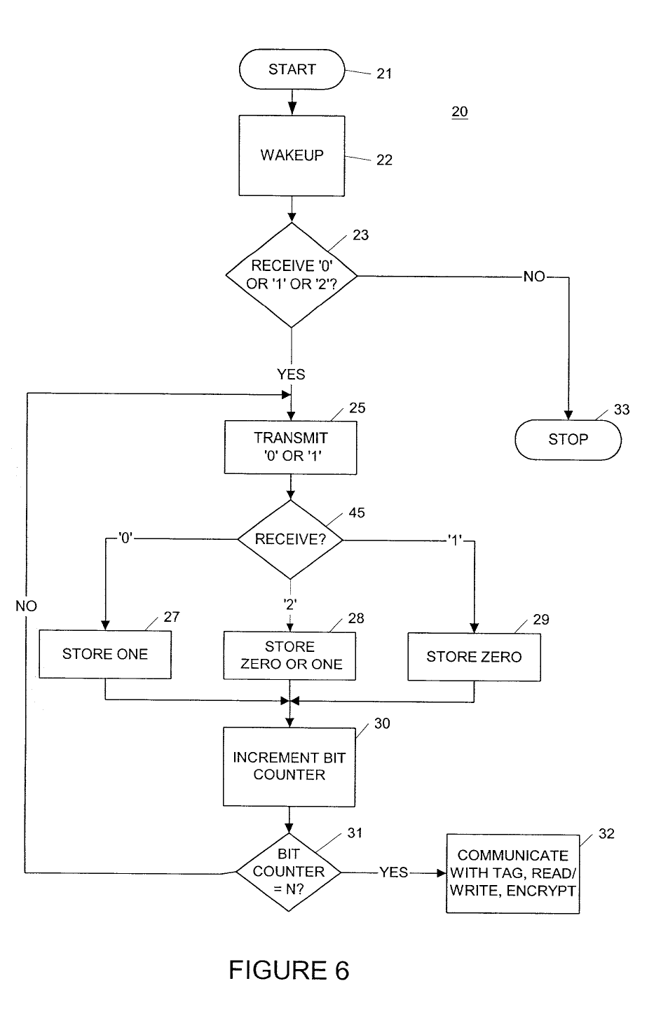

With reference to FIG. 6, an alternative embodiment of an algorithm to control the reader 11 is shown. In this embodiment, the algorithm starts at box 21. The reader 11 then sends a wake-up signal to the tags (box 22). If the reader 11 does not get a signal from the tags 16, the reader 11 stops (box 33). However, if the reader 11 does get a signal from the tags 16, the reader 11 transmits a ‘0’ signal or a ‘1’ signal as shown in box 25. Depending on whether the reader 11 had received a ‘0’ signal, a ‘2’ signal, or a ‘1’ signal, (see box 45) the reader 11 will store a “one” or a “zero” as indicated at boxes 27, 28 and 29. With a value stored for a bit of the identification code of a tag, the reader then increments the bit counter (box 30). If the bit counter does not equal the total number of bits in the identification codes of the tags, the reader 11 then transmits a new acknowledgment signal responsive to a newly received signal from the tags (box 25). The process is repeated until the bit counter does equal the total number of bits in the tag identification codes (they all have the same number of bits). When this is accomplished, the reader 11 communicates the identification confirmation to the selected tag (box 32).

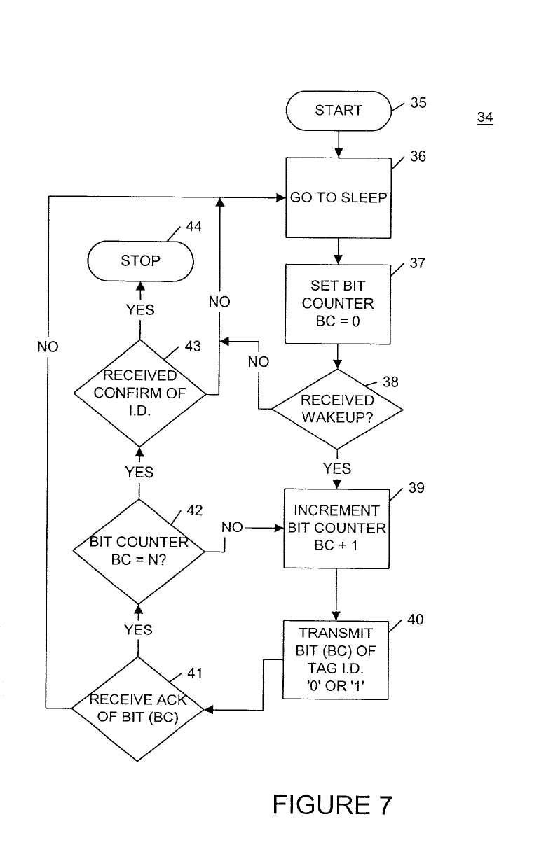

Referring to FIG. 7, a flowchart for a tag algorithm 34 is shown. The tag algorithm 34 starts as indicated at start box 35. A tag 16 immediately goes into a sleep or inactive mode as indicated at block 36. The tag's bit counter is then reset to 0 as indicated at block 37. At decision block 38, the tag determines whether a wake-up signal has been received from the reader 11. If no wake-up signal has been received, control of the algorithm 34 returns to block 36 where the tag is instructed to return to a sleep mode. At decision block 38, if a wake-up signal has been received from the reader 11, the tag 16 increments the bit counter by 1, as indicated at block 39. Next, the tag 16 transmits a ‘0’ signal or ‘1’ signal corresponding to a bit of the tag's identification code. The tag 16 will send the bit which corresponds to the value of the bit counter. This transmission is described at block 40 of the flowchart. The tag 16 then determines whether an acknowledgment of the bit transmission has been received from the reader 11 as shown at block 41. If no acknowledgment from the reader 11 is received after a period of time, the tag 16 goes to sleep and control is returned to block 36 of the algorithm 34. If the acknowledgment is received from the reader 11, the tag 16 determines whether the bit counter equals the total number of bits in the tag identification code (N), as shown at block 42. If the bit counter does not equal the total number of bits, control of the algorithm is returned to block 39 where the bit counter is incremented by 1. The tag 16 transmits the next bit of its tag identification code, and a determination is made whether the tag has received an acknowledgment of the transmission. This process continues through blocks 39, 40, 41 and 42 until the bit counter is equal to the total number of bits in the tag identification code. When the bit counter becomes equal to the total number of bits, the tag 16 determines whether it has received the confirmation signal of the tag identification code from the reader 11 as indicated at block 43. If the confirmation is received, the algorithm stops at block 44. If no confirmation is received, the tag 16 goes to sleep or becomes inactive as indicated at block 36.

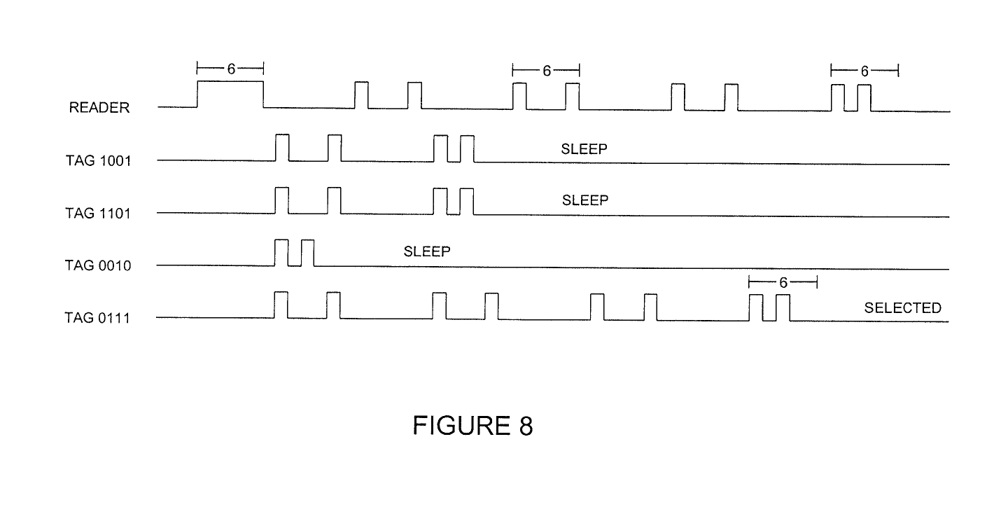

Referring to FIG. 8, an example of the process is provided wherein tag having identification code number 0111 is selected. In this particular example, four different tags 16 having identification numbers 1001, 1101, 0010 and 0111 are simultaneously communicating with the reader 11. The reader 11 first transmits a wake-up signal similar to that described with reference to FIG. 4A. In response, all four tags 16 transmit the first bit of their identification codes (note that the identification codes are read from right to left). The ‘0’ signal and ‘1’ signal are similar to those described previously with reference to FIG. 4B. Since at least one tag transmits a ‘1’ signal and at least one other tag transmits a ‘0’ signal, the reader 11 receives a ‘2’ signal (not shown) in FIG. 8. This signal is similar to that described previously with respect to FIG. 4B. In response to the first transmission signals from all four tags 16, the reader 11 transmits an acknowledgment ‘1’ signal. Since tag 16 having identification code 0010 had previously transmitted a ‘0’ signal, this tag goes to sleep. The remaining three tags 16 transmit a second bit of their identification codes having received the acknowledgment of their first bit transmission signals. In particular, the three tags simultaneously transmit two ‘0’ signals and one ‘1’ signal. Again, the reader receives a ‘2’ signal (not shown). In this example, the reader 11 again transmits a ‘1’ acknowledgment signal to the three tags which remain awake. Since they had transmitted ‘0’ signals, tags having codes 1001 and 1101 go to sleep or become inactive. The only remaining tag is the tag having identification code 0111. This tag now transmits its third bit of its identification code by sending a ‘1’ signal. The reader 11 receives this signal and responds with an acknowledgment ‘1’ signal. Since the tag's last transmission has been acknowledged, tag 0111 transmits its final bit signal. Of course, this is a ‘0’ transmission signal. The reader 11 acknowledges this signal by sending a ‘0’ acknowledgment signal. Since all four bits have now been acknowledged, tag having identification code 0111 is selected by the reader 11.

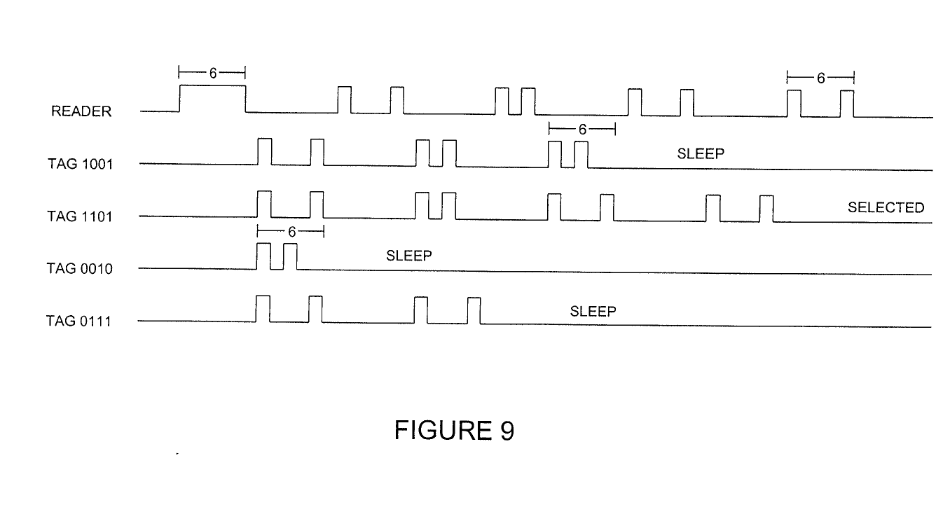

Referring to FIG. 9, a second example is shown wherein tag having identification code 1101 is selected. This example is similar to that shown in FIG. 8 wherein four tags having similar tag identification codes are in communication with the reader. The reader 11 initializes the tag 16 by sending its wake-up signal. In response, all four tags transmit signals corresponding to the first bit of their identification codes. The reader 11 receives from the tags a ‘2’ signal. In response, the reader 11 transmits a ‘1’ acknowledgment signal. Since tag 0010 had transmitted a ‘0’ signal, it now goes to sleep. The three remaining tags, however, now transmit signals corresponding to the second bits of their identification numbers. Again, the reader receives a ‘2’ signal from the three remaining tags 16. In this example, the reader acknowledges with a ‘0’ acknowledgment signal. Since tag having identification code 0111 had sent a ‘1’ signal, it now goes to sleep. The two remaining tags, however, now transmit signals corresponding to the third bits of their identification codes. Again, the signal received from the tags by the reader 11 is a ‘2’ signal. This time the reader 11 transmits a ‘1’ acknowledgment signal. Since this is not the acknowledgment tag having identification code 1001 was looking for, it now goes to sleep. Since tag 1101 did get a match, it now transmits its signal corresponding to its final bit of its identification code. Of course, as shown in FIG. 6, this transmission is a ‘1’ signal. The reader 11 acknowledges this transmission with its own transmission of a ‘1’ acknowledgment signal. Tag having identification code 1101 is then selected and identified.

A significant advantage of the invention as described is that tag 16 may be prioritized for selection and identification. In particular, the reader 11 may be programmed to transmit a particular acknowledgement signal every time it receives a ‘2’ signal from the tags. Reference is again made to FIG. 5 wherein at decision block 23, the reader 11 must determine whether it has received ‘0’, ‘1’, or ‘2’ signals from the tags. Priority is accomplished among the tags by assigning high priority tags with ‘1’ values for the more significant bits of the identification numbers. Thus, as shown in FIG. 5, at block 25, the reader 11 may be programmed to transmit a ‘1’ acknowledgment signal every time the reader 11 receives a ‘2’ signal. Thus, in this example, if there are 2 or more tags competing for identification by the reader, the reader will acknowledge those tags transmitting ‘1’ signals corresponding to the bits of their identification numbers. Thus, tags having identification numbers comprising ‘1’ will be given priority over those having identification numbers comprising ‘0’. The example shown with reference to FIG. 8 is illustrative of a priority system, wherein a ‘1’ signal is always transmitted in response to the reader receiving a ‘2’ signal from the tags. Alternatively, the example described with reference to FIG. 9 is illustrative of a non priority system wherein the acknowledgment signal is randomly selected upon reception by the reader 11 of a ‘2’ signal from the tags 16.

The present invention, therefore, is well adapted to carry out the objects and attain the ends and advantages mentioned, as well as others inherent therein. While presently preferred embodiments of the invention have been given for purposes of disclosure, numerous changes in the details of procedures for accomplishing the desired results, will readily suggest themselves to those skilled in the art, and which are encompassed within the spirit of the invention and the scope of the appended claims.

What is claimed is:

1. A method for identifying tags with a reader, wherein the tags have unique tag identification codes, said method comprising:
transmitting a wake-up signal from the reader to a tag within a field of the reader;
transmitting a signal corresponding to an initial portion of the tag identification code from the tag to the reader;
transmitting from the reader to the tag an initial acknowledgement signal responsive to the signal corresponding to the initial portion of the tag identification code; and
storing in the reader an initial portion of a tag confirmation code corresponding to the initial acknowledgement signal.

2. A method as claimed in claim 1, further comprising:
transmitting to the reader a signal corresponding to a subsequent portion of the tag identification code from the tag, wherein the initial portion of the tag identification code for the tag has been acknowledged by the acknowledgement signal;
transmitting from the reader to the tag a subsequent acknowledgement signal responsive to the signal corresponding to the subsequent portion of the tag identification code; and
storing in the reader a subsequent portion of the tag confirmation code corresponding to the subsequent acknowledgement signal.

3. A method as claimed in claim 2, further comprising:
determining whether the number of signals corresponding to portions of the tag identification code sent to the reader from the tag equals the total number of tag identification code portions.

4. A method as claimed in claim 2, further comprising:
transmitting a tag identification confirmation signal from the reader to the tag.

5. A method as claimed in claim 1, further comprising:
deactivating the tag within the field upon the tag's reception of an acknowledgement signal from the reader which does not acknowledge a just-transmitted signal corresponding to a portion of the tag identification code from the tag.

6. A method as claimed in claim 1, wherein the initial acknowledgement signal acknowledges a prioritized tag.

7. A method as claimed in claim 1, wherein said transmitting a signal corresponding to an initial portion of the tag identification code from the tag to the reader comprises transmitting a plurality of signals corresponding to initial portions of a plurality of tag identification codes from a plurality of tags.

8. A method for identifying tags with a reader, said method comprising:
a) transmitting a wake-up signal from the reader to a tag within a field of the reader;
b) transmitting a signal corresponding to an initial portion of a tag identification code from a tag to the reader, wherein all tags have unique tag identification codes;
c) transmitting from the reader to a tag an acknowledgement signal responsive to the signal corresponding to the initial portion of the tag identification code;
d) storing in the reader a portion of a tag confirmation code corresponding to the acknowledgement signal;
e) deactivating a tag in the field upon the tag's reception of an acknowledgement signal from the reader which does not acknowledge a just-transmitted signal corresponding to a portion of the tag identification code from the tag;
f) repeating steps b), c), d) and e) with respect to subsequent portions of the tag identification code for a tag in the field having an initial portion of the tag identification code which has been acknowledged by the acknowledgement signal; and
g) transmitting a tag selection signal to a tag in the field upon compilation of the tag confirmation code.

9. A method as claimed in claim 8, wherein said transmitting from the reader to a tag an acknowledgement signal responsive to the signal corresponding to the initial portion of the tag identification code acknowledges a high priority tag.

10. A method as claimed in claim 8, further comprising:
determining whether the number of signals corresponding to portions of the tag identification code sent to the reader from a tag in the field equals the total number of tag identification code portions.

11. A method as claimed in claim 8, further comprising:
deactivating the only remaining active tag in the field after transmission of the tag selection signal.

12. A method as claimed in claim 8, further comprising:
repeating steps a), b), c), d), e) and f) to select an additional tag in the field.

13. A method as claimed in claim 8, wherein said transmitting a signal corresponding to an initial portion of a tag identification code from a tag to the reader, wherein all tags have unique tag identification codes comprises transmitting a plurality of signals corresponding to an initial portion of a tag identification code from a plurality of tags.

14. A method as claimed in claim 8, further comprising: h) communicating with the selected tag via a command set.

15. A system for identifying objects within a field, said system comprising:
a reader comprising a transmitter, a receiver and a processor, wherein the transmission range of the transmitter and receiver define the field;
a plurality of tags each comprising a transmitter, a receiver and a microprocessor, wherein the tags are attachable to the objects to be identified, wherein each tag has a unique tag identification code and all codes are the same length, wherein the tags operate in active and inactive modes;
wherein said reader transmits a wake-up signal from the reader to all tags in the field, whereby all tags in the field are made to be in the active mode;
wherein all active tags within the field transmit a signal corresponding to an initial portion of their tag identification codes to the reader;
wherein said reader transmits to all tags in the field an acknowledgement signal responsive to the tag signals corresponding to initial portions of the tag identification codes; and
wherein said reader stores an initial portion of a tag confirmation code corresponding to an acknowledgement signal.

16. A system as claimed in claim 15, wherein the tags switch from the active mode to the inactive mode upon receipt of an acknowledgement signal transmission from the reader which does not acknowledge their last transmitted signal corresponding to a portion of their tag identification code.

17. A system as claimed in claim 15, wherein the tags remain in the active mode upon receipt of an acknowledgement signal transmission from the reader which does acknowledges their last transmitted signal corresponding to a portion of their tag identification code.

18. A system as claimed in claim 17, wherein upon receipt of an acknowledgement signal transmission from the reader which does acknowledges their last transmitted signal corresponding to an initial portion of their tag identification codes, the tags transmit a signal corresponding to a subsequent portion of their tag identification codes.

19. A system as claimed in claim 15, further comprising a counter of the number of portions of the tag identification code transmitted by tags in the field.

20. A system as claimed in claim 15, wherein said reader transmits an identification confirmation signal from the reader to a tag in the field, once all tag identification code portions are received from the tag.

21. A system as claimed in claim 15, wherein said reader transmits an acknowledgement signal to acknowledge tag transmitted signals corresponding to high priority portions of tag identification codes, whereby higher priority tags are selected before lower priority tags.
